(19) United States
(12) Patent Application Publication
(10) Pub. No.: US 2021/0287206 A1
(43) Pub. Date: Sep. 16, 2021

(54) PHYSICAL CONTAINER CONTAINING AN ELECTRONIC WALLET DEVICE

(71) Applicant: VISA INTERNATIONAL SERVICE ASSOCIATION, San Francisco, CA (US)

(72) Inventors: Michael GRAY, MONROE, WA (US); Andrew HICKEY, ISSAQUAH, WA (US); Srinivas TADIPARTI, BELLEVUE, WA (US); Mona GARG, MERCER ISLAND, WA (US); Premkumar RAVIKUMAR, BOTHELL, WA (US)

(21) Appl. No.: 16/316,314

(22) PCT Filed: Jul. 8, 2016
(86) PCT No.: PCT/US16/41473

§ 371 Date: Jan. 8, 2019

(51) Int. Cl. G06Q 20/36; G06Q 20/40; G06Q 20/20

(52) U.S. Cl. CPC G06Q 20/36; G06Q 20/201; G06Q 20/401

(57) ABSTRACT

The system may determine the items in the shopping container and may access the virtual wallet installed in the shopping container to allow the consumer to complete a purchase using the mobile wallet on the shopping container.

### BACKGROUND

Merchants have long tried to make shopping in physical locations easier, faster and more efficient. Numerous attempts have been made to try to make the shopping experience easier, from creating lines for customers with a limited number of products to using bar codes to speed checkout.

In addition, merchants have attempted to make paying for goods and services easier, faster and more efficient. However, users often have to stand in a line and wait for their turn to pay for goods and services. It would be useful to have a way for consumers to pay for good or services without having to stand in line or having to wait for a turn to access a payment terminal.

### SUMMARY

The described system and method may improve the payment experience for users by creating a shopping container that has a processor to receive the price of goods and access an electronic payment wallet to allow a user to pay for goods using the shopping container, thus eliminating the need to stand in line to wait a turn for a payment terminal. The system may determine the items in the shopping container and may access the virtual wallet installed in the shopping container to allow the consumer to complete a purchase using the mobile wallet on the shopping container.

### BRIEF DESCRIPTION OF THE DRAWINGS

FIG. 1 is a high level view of the hardware in the system;

FIG. 2 is view of the elements of the portable computing device;

FIG. 3 is a high level view of the hardware in the system including a token server;

FIG. 4 is a flow chart of the computer executable blocks executed by the system for a sample payment;

FIG. 5 is a flowchart of the computer executable blocks executed by the system in determining prices in the physical container;

FIG. 6a illustrates a portable computing device attached to physical container being charged over an induction charging mat;

FIG. 6b illustrates a portable computing device attached to physical container being charged via solar panels; and

FIG. 6c illustrates a portable computing device attached to physical container being charged in an electrical outlet.

### SPECIFICATION

Merchants have long tried to make shopping in physical locations easier, faster and more efficient. Numerous attempts have been made to try to make the shopping experience easier, from creating lines for customers with a limited number of products to using bar codes to speed checkout.

In addition, merchants have attempted to make paying for goods and services easier, faster and more efficient. However, users often have to stand in a line and wait for their turn to pay for goods and services. It would be useful to have a way for consumers to pay for good or services without having to stand in line or having to wait for a turn to access a payment terminal.

The described system and method may improve the payment experience for users by creating a shopping container that has a processor to receive the price of goods and access an electronic payment wallet to allow a user to pay for goods using the shopping container, thus eliminating the need to stand in line to wait a turn for a payment terminal. The system may determine the items in the shopping container and may access the virtual wallet installed in the shopping container to allow the consumer to complete a purchase using the mobile wallet on the shopping container.

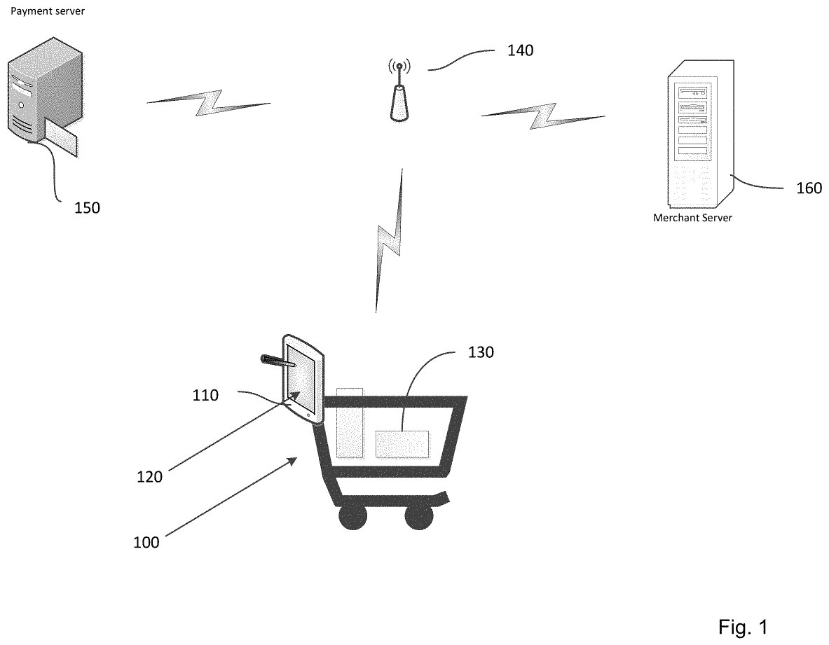

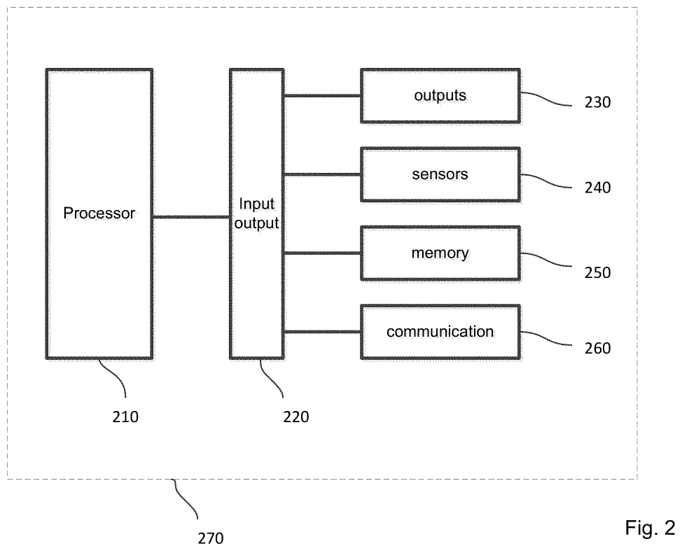

Referring to FIG. 1 may be a high level illustration of the physical elements of the system. A shopping container 100 may be a shopping cart or a shopping basket or a shopping bag any other container that a user may use to assist a user in shopping and hold physical goods 130. On the shopping container 100 may be a portable computing device 110 that may have a wallet application pre-installed. Logically, there may be a plurality of applications loaded on the computing device 110 such as an application that is specific to the physical location of the merchant. One of the applications may be a mobile wallet application 120.

The mobile wallet 120 may be an application which assists in making payments. A user may set up an account which is accessed through a user name and a password or other type of verification. The user may add one or more payment devices or accounts to the wallet application 120. Once signed in and authenticated, a user may use one or more of the added accounts to pay participating merchants.

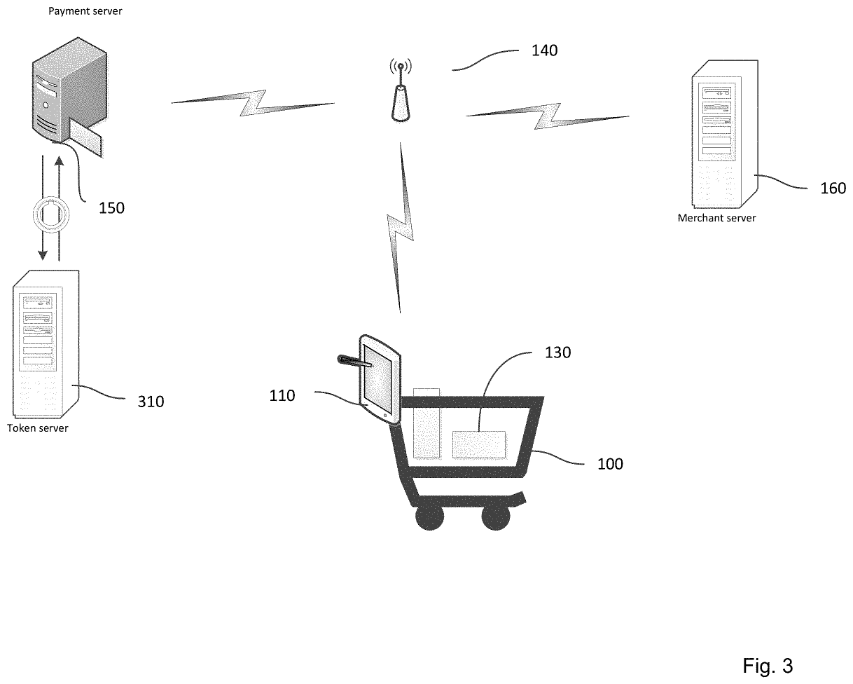

In another aspect, the mobile wallet may use tokens to represent a personal account number (PAN) rather than the PAN itself. A token server 310 (FIG. 3) may store the PAN for users and may issue short term tokens to create transactions. The tokens may be verified by the token server 310, thus allowing transactions to occur but keeping PANs secure.

The physical container 100 may contain hardware to enable the process to operate efficient. Sample hardware may include a processor 210, an input/output circuit 220, a display 230, sensors 240, memory 250 and communication devices 260. The hardware may be encased in a separate housing 270 or may be integral to the physical container 100. The housing 270 may be permanently attached to the physical container 100 or may be attached in a manner that an authority may release the housing 270 and hardware therein for maintenance, power recharging, cleaning, upgrades, etc.

Logically, a processor 210 may be part of the physical container 100. The processor 210 may be physically configured to operate the relevant applications used by the system. The processor 210 also may be physically configured to safe on power usage as maintaining adequate power levels may be a challenge. Further the processor 210 may be configured to withstand a variety of temperatures and weather conditions as the container may be left outside for periods of time.

The input output circuit 220 may control communication in and out of the processor and may be in communication with the input output circuit 220. The input output circuit 220 may determine the priority of messages to proceed to and from the processor 210.

The hardware may also include a variety of sensors 240 which may be communication with the input output circuit. The sensors may server a variety of needs and functions and may be physically designed to meet the desired function. In one aspect, the sensors may include GPS sensors which may help a merchant know where the container 100 is in relation to a physical location. In another aspect, the sensors may include fingerprint sensors which may be part of an image capture device. The fingerprint sensor and image capture device may be used to verify a current user is sufficiently similar to known users. The image capture device may also be used to assist in determining a location in a merchant location and to determine consumer interest. Touch sensors may also be used as input devices in the situation where the display may not be touch sensitive. The touch screen or touch sensors may be used to input user names and passwords or other information that may be used by an application. A microphone may be used to receive voices and background noises to authenticate a user by determining if sounds are sufficiently similar to expected sounds. which senses items placed in the physical container.

A communication circuit may be used to communicate data to outside processors. The communication may take on a variety of wireless forms such as wifi, Bluetooth, BLE, infrared, etc. The communication may be used for a variety of purchases such as looking up prices for items, looking up nutritional information on products, looking for offers, communicating a payment intent, communicating a payment completion, etc. The format of the communication may be many and varied.

Logically, the hardware may include a memory 250. In some instances, the memory 250 merely serves to assist the processor 210 in cuing data to be analyzed. In other instances, the memory 250 may store prices and information on products in a store such that the data may be promptly accessed.

The hardware may include output devices 230 such as a display 230 or a speaker. The display 230 may be touch sensitive and may have a variety of functions such as displaying apps, maps, input displays, wallet apps, etc. As mentioned previously, the display 230 may be adapted to withstand harsh weather conditions and heavy use from a variety of users. The speaker 230 may be used to further enhance a user's experience in a store, from playing music desired by the user to informing the user about a sale in a specific section of a store.

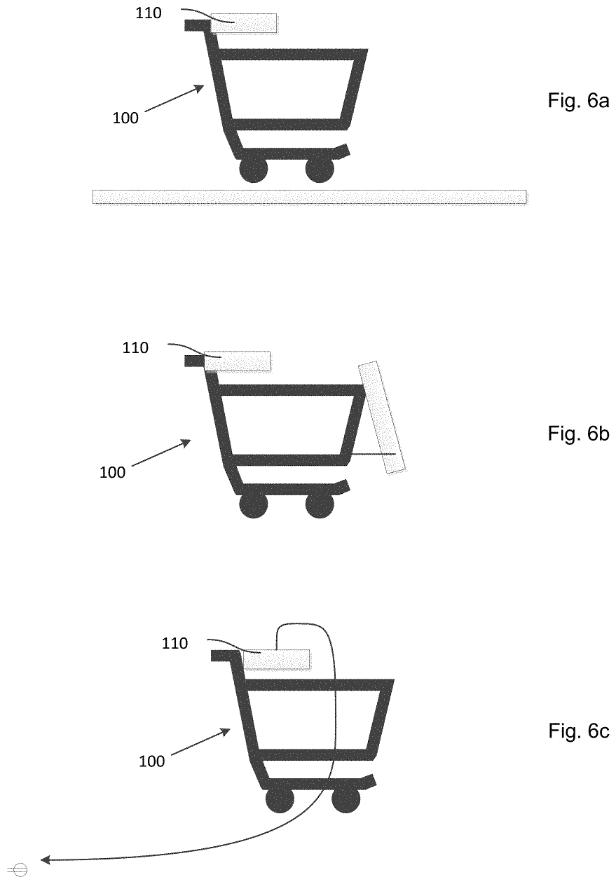

The hardware also may include a portable power source. In some embodiments, the power source may be rechargeable. The power source may be recharged in a variety of ways. In some embodiments, the power source may be charged when the physical container is not in use such as when the store is closed. In some embodiments as illustrated in FIG. 6c, the computing device 110 may be pulled into a charger. In other embodiments, if the physical container is a cart, it may have generators in the wheels that recharge the power source. In another embodiment as illustrated in FIG. 6b, the cart may have solar cells which recharge the power source. In yet another embodiment as illustrated in FIG. 6a, induction is used to charge the power source when the physical container is located over an induction power source.

The hardware may also include a communication source 140. The communication source 140 may be a Wi-Fi access point 140 that may communicate with the computing device 110 and may also be in wired or wireless communication with the payment server 150 and a merchant server 160. The payment server 150 may assist payments in being approved and account for the funds being moved to the proper parties. The merchant server 160 may assist in providing pricing and identification of goods in a store. The merchant server 160 may also provide guidance to a user in the store, may provide offers and discounts based on the purchase history of a consumer and the location in the store, etc.

As the computing device 110 is designed primarily to execute the wallet application and some store applications and not be a general purpose computing device 110, it may be able to add additional security to the computing device 110. For example, communication between the access point 140 and computing devices 110 may be limited to known MAC address for the computing devices. All other MAC addresses may be blocked. Similarly, digital fingerprints of the computing devices 110 may be created using MAC address, processor serial numbers, known security chips, undisclosed password, hidden networks, etc., to ensure that communication between the computing device 110 and the access point 140 are more secure than traditional Wi-Fi security.

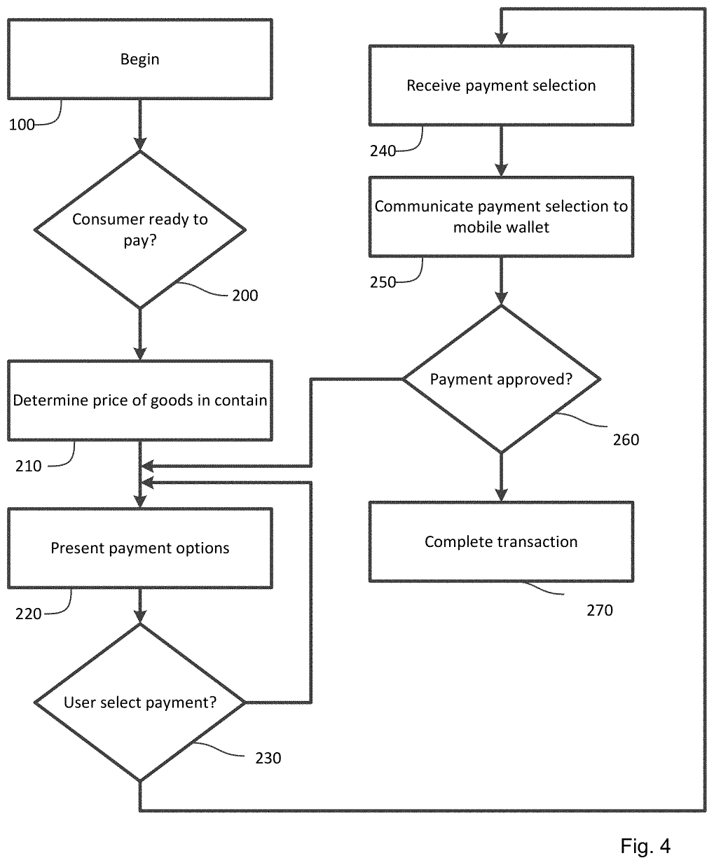

FIG. 4 may illustrate one or more blocks of logic flow which may be used to physically configure the processor to execute to enable the process. At block 200, the computer executable instructions may 200 determining that a consumer is ready to pay for the items in the container. In one embodiment, the user may select on the display to begin the checkout. In another embodiment, the user may move the physical container to an area designated as being a checkout area. The checkout area may have a communication link that is dedicated to communicate payment information to and from the payment server. By pushing the physical container 100 into the checkout area, the wallet app 120 on the computing device 100 may be activated.

At block 210, the total price of the items in the container may be determined. Determining the price of goods 130 in a physical cart 100 may occur in a variety of ways. In one embodiment, a grocery store scanner is used to determine the price of items 130 in the shopping container 100 and the price is communicated to the portable computing device 100 where the prices and total are displayed to the user for approval and payment through the virtual wallet application operating on the portable computing device.

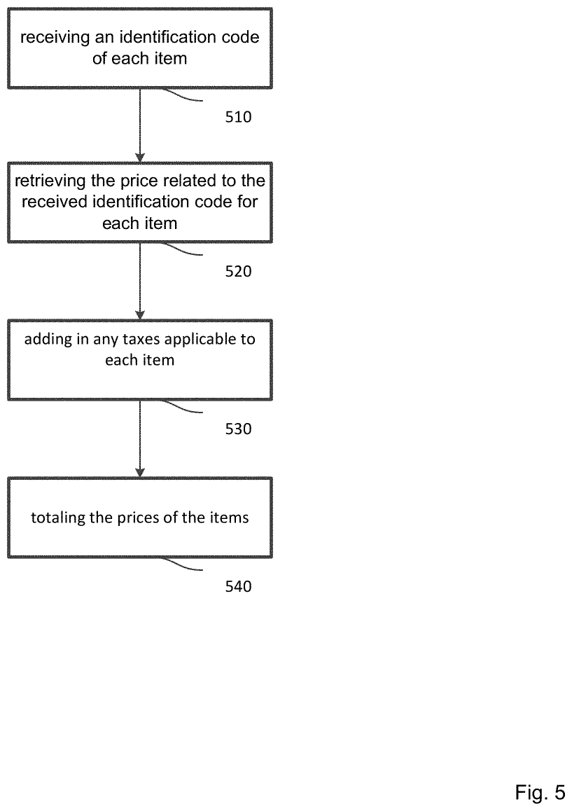

In another embodiment, the total price of the items in the container may be determined according to a series of computer executable blocks. Referring to FIG. 5, in one embodiment. an identification code of each item may be received at block 510. The identification code may be received in a variety of ways. In one embodiment, goods in a store may have an RF identifier and the price and identification of the good may be received via the RF ID. In another embodiment, only an identification of the good may be received and the identification may be communicated to the merchant server 160 where the merchant server 160 may respond with the price to the portable computing device 110 as called for in block 520. The identification of the good and the price of the good may be listed on the display. In yet another embodiment, the portable computing device 110 may have a bar code reader which may be part of the sensors. When an item is added to the physical container 100, the item may be scanned by the bar code reader and the price and identification may be retrieved from the memory or from the merchant server 160 as called for in block 520.

At block 530, the taxes applicable to each item may be determined. The taxes of each item on items may be varied. For example, taxes on medical supplies may be lower than taxes on alcohol. In one embodiment, the various taxes and the applicable items may be stored in a memory in the portable computing device 110. In another embodiment, the taxes on the items in the physical cart 100 may be retrieved from the merchant server 160. Of course, it should be noted that the merchant server 160 may be in the store itself and in other embodiments, the merchant server may be remote from the store.

At block 540, the prices of the items may be totaled. As the prices, taxes and quantities of the goods are in the portable computing device 110, the totaling of the items is relatively straightforward. The items, taxes and total may be displayed to the user on the portable computing device 110.

Referring again to FIG. 4, at block 220 the merchant payment application may present the consumer payment options in a mobile wallet for items in the physical container. As mentioned previously, a user may add one or more payment devices to the mobile wallet. For example, a user may have a first credit card (payment device) for business purposes and a second credit card (payment device) for personal purposes. Both credit cards may be added to the mobile wallet. At block 220, the consumer may select the payment device to be used for the transaction. The various payment devices may be represented by graphical images which may represent the various accounts. In some embodiments, a transaction may be split among more than one payment device.

At block 230, the system may determine if a payment device has been selected. If a payment device has not been selected, the method may return to block 220. If a payment device has been selected, control may pass to block 240. At block 240, the payment device selection may be received by the portable computing device 110. The portable computing device may receive the payment device selection from a user input on the touch screen on the portable computing device 110. At block 250, the payment selection may be communicated to the mobile wallet application.

At block 260, the system may determine whether the payment has been approved. In one embodiment, the PAN and the usual purchase information is passed to a payment server 150 which reviews the data and subjects it to an algorithm to determine if the transaction is rating as being over a threshold for not being fraudulent.

In another embodiment illustrated in FIG. 5, the mobile wallet may interface with a token service to provide tokens for payment. The tokens may be verified by the token server. As mentioned previously, the mobile wallet may use tokens to represent a personal account number (PAN) rather than the PAN itself. A token server 310 (FIG. 3) may store the PAN for users and may issue short term tokens to create transactions. The tokens may be verified by the token server 310, thus allowing transactions to occur but keeping PANs secure.

At block 270, in response to the payment selection being approved by the payment selection, the transaction may be complete. The physical container 100 may create at least one of indications the status of the payment such as payment in process, payment denied or payment successful. As a result, store employees may be confident that a customer may not be trying to leave a store without paying for goods. In one embodiment, the physical container 100 may have a series of lights which indicate the status of the payment.

The physical container may also collect additional inputs that may be communicated to the payment server 150 to assist in verifying and categories the transaction. As an example, the processor in the mobile computing device 110 may have a serial number. The serial number may be communicated and matched against known serial numbers to ensure the transaction is not fraudulent. Of course, the portable computing device may have a variety of input which may be used to create an electronic signature of indication of the computing device. In yet another embodiment, the physical container may include a biometric input and the input may be used to verify the consumer. For example, the handle may have a fingerprint reader and the fingerprint may be used to authenticate a user.

In yet another embodiment, the portable computing device 110 may communicate with a second portable computing device of a customer such as a smart phone of the customer. The second portable computing device may provide a variety of additional information, In one embodiment, the portable computing device may access discounts store in a memory of the second portable computing device which may be applied to a purchase. The discounts may be in an email or may be stored in a coupon folder. Similarly, portable computing device 110 may accesses a list in the memory of the second portable computing device, analyzes the list and directs the consumer to a location in the store to access the goods in the list. In yet another embodiment, the processor computing device 110 may access an inventory of goods of the consumer and in the second portable computing device and may indicate which goods need to be replenished.

Logically, the user configures the processor to act in a desired manner. For example, the merchant may have an app and the customer may load in a list into the merchant app. In the store and using the physical container, the portable computer 110 may remind the customer to buy the listed goods when walking past the goods in the store. In addition, the mobile wallet also may review the list in comparison to what was purchased and may remind a user that certain goods may have been forgotten. The user interface on the merchant application and on the wallet application may be modified in limited ways to make the applications more comfortable for the customer.

The user devices, computers and servers described herein may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS, UNIX, LINUX, MAC OS, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s). Alternatively, the user devices, computers and servers described herein may be special purpose computer devices and servers designed specifically for the tasks and routines disclosed.

The user devices, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated. The attached Appendix may provide more detail regarding the operation of a payment system.

The present disclosure provides a solution to the long-felt need described above. In particular, the systems and methods described herein may be configured for improving payment systems and offers. The offers may be based on data not previously studied as the data was too large and overwhelming to be properly reviewed in a meaningful way.

Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

The system and process may address several technical problems. By having the wallet application on the cart, a user no longer has to search to find a personal portable computing device. The computing device is already on the physical container. Further, the computing device may be optimized to process electronic wallet transactions. In addition, the portable computing device 110 may have additional security as the primary purpose is to make purchases using the electronic wallet. Thus, transactions may be faster and more secure and users may not have to wait in line to make purchase.

1. A physical container for accepting items to purchased comprising:
a processor that is physically configured according to computer executable instructions;
an input output circuit in communication with the processor;
a sensor in communication with the input output circuit which senses items placed in the physical container;
a communication circuit which communicated with outside servers to receive updated prices and facilitate purchases;
a memory in communication with the processor which stores identification of items and related prices;
a display in communication with the input output circuit that displays a list of items and related prices in the physical container and displays payment applications;
wherein the computer executable instructions comprise instruction for:
determining that a consumer is ready to pay for the items in the container;
determining the total price of the items in the container;
presenting a consumer payment options in a mobile wallet for items in the container;
receiving a payment selection from the payment options;
communicating the payment selection to a mobile wallet payment system;
in response to the payment selection being approved by the payment selection, indicating that the transaction is complete.

2. The physical container of claim 1, further comprising a portable power source wherein the power source is re-chargeable.

3. The physical container of claim 1, wherein determining the total price of the items in the container comprises receiving a signal from a register that represents the total price.

4. The physical container of claim 1, wherein determining the total price of the items in the container comprises:
receiving an identification code of each item;
retrieving the price related to the received identification code for each item;
totaling the prices of the items; and
adding in any taxes applicable to each item.

5. The physical container of claim 4, wherein the identification codes are received through an RF receiver.

6. The physical container of claim 4, wherein the identification codes are received through a bar code reader.

7. The physical container of claim 1, wherein mobile wallet comprises a plurality of payment devices.

8. The physical container of claim 1, wherein the mobile wallet illustrates the plurality of payment devices with physical representations of the plurality of accounts.

9. The physical container of claim 1, wherein the mobile wallet interfaces with a token service to provide tokens for payment and wherein the tokens are verified by the token server.

10. The physical container of claim 1 wherein the container creates at least one of indications of :
Payment in process;
Payment denied;
Payment successful.

11. The physical container of claim 1, wherein the input output circuit communicates with an input device which accepts inputs from a user.

12. The physical container of claim 11, wherein the inputs comprise letters and numbers representing a user name and a user password.

13. The physical device of claim 11, wherein the inputs comprise an electronic signal from a computing device controlled by the user.

14. The physical device of claim 11, wherein the processor communicates with a portable computing device of a user.

15. The physical device of claim 14, wherein the processor access discounts store in a memory of the portable computing device.

16. The physical device of claim 1, wherein the processor accesses a list in the memory of the portable computing device, analyzes the list and directs the consumer to a location in the store to access the goods in the list.

17. The physical device of claim 1, wherein the processor receives communications from communication devices in the merchant location and displays the communications to the consumer.

18. The physical device of claim 1, wherein the processor accesses an inventory of goods of the consumer and indicates which goods need to be replenished.

19. The physical device of claim 1, wherein the device comprises a biometric input and input is used to verify the consumer.

20. The physical container of claim 1, wherein user configure the processor to act in a desired manner.
